(19) United States
(12) Patent Application Publication
(10) Pub. No.: US 2016/0371685 A1
(43) Pub. Date: Dec. 22, 2016

(54) SYSTEM, APPARATUS AND METHOD FOR PROVIDING RANDOMLY GENERATED CODES IN A USER ANONYMOUS MANNER

(71) Applicants: Ned M. Smith, Beaverton, OR (US); William C. Deleeuw, Beaverton, OR (US); Rajesh Poornachandran, Portland, OR (US)

(72) Inventors: Ned M. Smith, Beaverton, OR (US); William C. Deleeuw, Beaverton, OR (US); Rajesh Poornachandran, Portland, OR (US)

(21) Appl. No.: 14/740,572

(22) Filed: Jun. 16, 2015

(51) Int. Cl. G06Q 20/40; G06Q 20/10; G06F 7/58

(52) U.S. Cl. CPC G06Q 20/40; G06F 7/582; G06Q 20/4016; G06Q 20/10

(57) ABSTRACT

In one embodiment, a processor comprises: a first logic to receive a random number associated with a user of a first computing system, generate a first pseudo random number seed based on the random number, the first pseudo random number seed associated with a first account of the user, and generate a sequence of pseudo random number seeds based on the first pseudo random number seed, where a first leaf of the sequence of pseudo random number seeds comprises a one time value associated with the first account; and a communication logic to communicate the one time value to a second computing system associated with a merchant, where a credit entity is to authorize a transaction occurring at a first time quantum based at least in part on the one time value. Other embodiments are described and claimed.

### TECHNICAL FIELD

Embodiments described herein generally relate to enabling users to enter into transactions in a user anonymous manner.

### BACKGROUND

There are a number of situations in which a consumer or other user is required to share sensitive information such as credit score, social security number, credit card details (name, account number, address, PIN, etc.) with lenders, service providers (mobile phone, Internet, etc.) and with merchants for purchases made. This information combined with other customer information made available via social media can be easily exploited by malicious users. While controlled payment numbers and credit card masking may be used as anti-fraud measures, limitations exist, including the risk of unauthorized user information access, difficulty of providing a credit for a transaction to a consumer after expiration of a virtual credit card number, and so forth.

### BRIEF DESCRIPTION OF THE DRAWINGS

FIG. 1 is a block diagram of an exemplary architecture for controlling user information consistent with an embodiment.

FIG. 2 is a block diagram of operation of an entropy multiplexer consistent with various embodiments.

FIG. 3 is a block diagram of an architecture that is arranged in a seed encoding tree structure in accordance with one embodiment.

FIG. 4 is a block diagram of an encoding of an OTV credit card number based on a date/time PRN tree correlation in accordance with one embodiment.

FIG. 5 is an example transaction flow using an OTV in accordance with an embodiment.

FIG. 6A is a flow diagram of a method in accordance with an embodiment of the present invention.

FIG. 6B is a tree structure that encodes both time and transaction amount in accordance with an embodiment of the present invention.

FIG. 7 is a flow diagram of a method for handling an incoming transaction from a clearing house point of view in accordance with an embodiment.

FIG. 8 is an example transaction flow for a transaction clearing process in accordance with another embodiment in which credit scoring information is included.

FIG. 9 is a flow diagram of a method for generating a credit score transaction code in a user device in accordance with an embodiment.

FIG. 10 is a flow diagram of a method for generating a credit score transaction code at a credit service provider in accordance with an embodiment.

FIG. 11 is a block diagram of an example system with which embodiments can be used.

FIG. 12 is a block diagram of a system in accordance with another embodiment of the present invention.

### DETAILED DESCRIPTION

In accordance with various embodiments, using a technique that is termed herein “entropy multiplexing” (EM), seed tree encoding may be used to provide codes used for financial and other secure transactions without the need for communication of user identifying information. In some embodiments, the EM techniques may be implemented using one or more computing systems include one or more hardware processors such as a central processing unit (CPU) providing support for digital random number generation (such as made available in an Intel® processor using an Intel® Digital Random Number Generator (DRNG)) and Intel Advanced Encryption Standard New Instructions (AESNI) technologies. As used herein, the term “random number” may refer to a true random number or a pseudo random number depending upon context, and absent an explicit indication, may refer to either a true random number or pseudo random number. Note that embodiments may implement Seed Tree Encoding using Entropy Multiplexing (STEEM)-related operations by providing for random number generation and handling within a trusted execution environment to enable anonymous communication of codes usable for a wide variety of transactions with selective, and time-bounded, access control. This is accomplished by use of pseudo random number generators and distribution of random number seeds among parties involved in a transaction. As detailed below, in particular embodiments the level of access control may be controlled by time bounding in which a hierarchy of random number seeds are managed to allocate access to such codes provided over different time periods.

As such, embodiments may use STEEM techniques to enable anonymous storage of sensitive customer information with fine granular selective time/location bounded access control. Different levels of access control can be achieved without the use of complex cryptography, management, key provisioning, etc., and without sharing sensitive data.

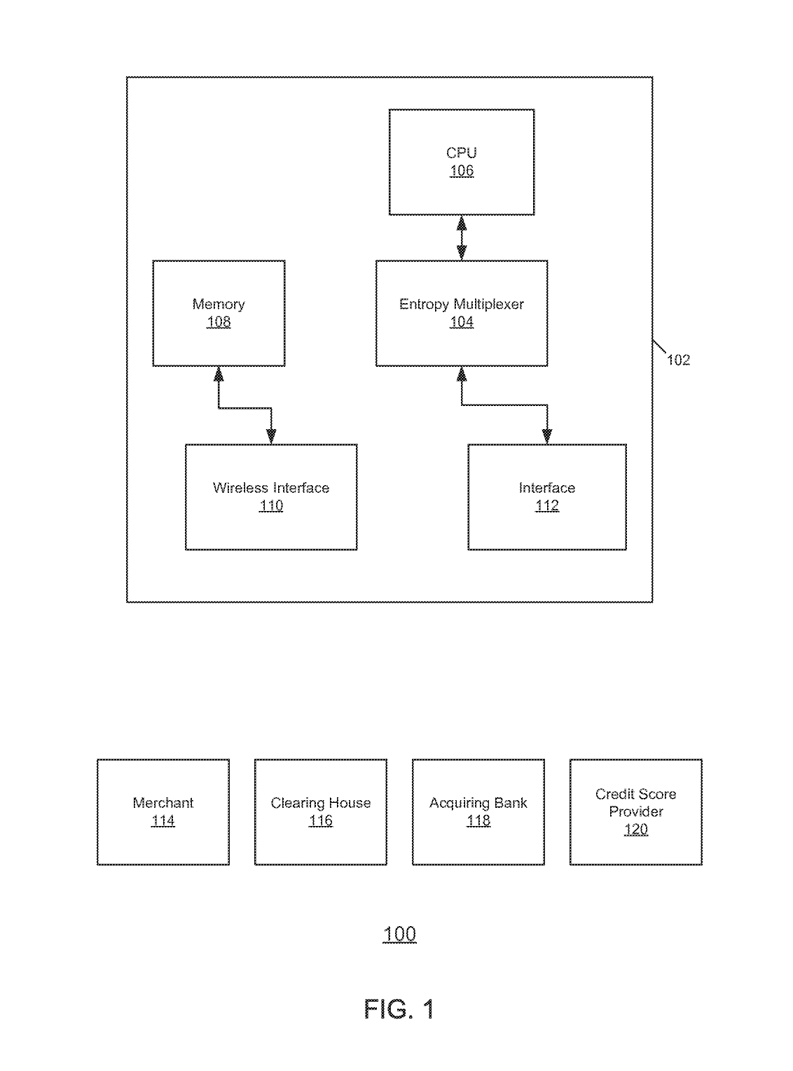

FIG. 1 depicts an exemplary architecture 100 for controlling user information consistent with an embodiment. In architecture 100 a user device 102 deployed by the user may be a mobile device such as a mobile phone, smartphone, tablet computer, laptop computer or other mobile device. Embodiments however are not limited in this context. User device 102 includes a processor circuit referred to herein as a CPU 106, a memory 108, a wireless interface 110, and an interface 112. User device 102 additionally includes an entropy multiplexer 104 whose operation is detailed with respect to the figures to follow. In brief, however, entropy multiplexer 104 may generate One Time Virtual (OTV) credit card or other OTV numbers that can be used to anonymously perform a transaction in which user identifying information is not disclosed to a merchant, and by which backend services can access secure records of the user to determine whether and to what extent a given transaction is permitted. Note that the term “OTV” as used herein encompasses both digital values that can be used a single time for a single transaction, as well as digital value that can be used for a limited time for a limited number of transactions occurring within a given (typically short) time period. As detailed below, the manner in which the pseudo random numbers are generated allows them to be communicated to third parties in a manner without compromising the anonymity of user information.

Entropy multiplexer 104 may comprise various hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

During the course of operation, user device 102 may generate a sequence of pseudo random number seeds usable as OTVs as described herein. More specifically, these OTVs can be provided to external entities in a user anonymous manner to enable transactions to be completed with merchants or other third parties in a manner that provides a high level of security with respect to user identification information (as such information is not provided with the OTV number). More specifically, as illustrated in FIG. 1, user device 102 can be in communication, directly or indirectly with a number of external entities. As illustrated, these entities include a merchant 114, which may be a traditional brick and mortar retailer or an online merchant. In turn, merchant 114 may be in communication with a clearing house 116, which is an independent entity that provides clearing house functions for credit-based transactions. More specifically, clearing house 116 may be a given financial institution that has a computing environment including one or more server computers that are configured to provide clearing and settlement services for credit-based transactions. In turn, clearing house 116 can be in communication with an acquiring bank 118. In turn, acquiring bank 118 may be a given bank or other financial institution that processes credit or debit card payments on behalf of merchant 114. As such, acquiring bank 118 may provide a computing environment including one or more server computers configured to perform such processing. As further illustrated in FIG. 1, acquiring bank 118 may further be in communication with a credit score provider (CSP) 120. CSP 120 may be a credit score institution that performs credit analysis for consumers and/or other entities and may provide such credit scores to various entities, including one or more of the entities described herein.

In turn, such entities may selectively determine whether to extend credit to allow a transaction to proceed (and/or determine an appropriate level of credit extension) based on such credit score. As such, credit score provider 120 may provide a computing environment including one or more server computers configured to perform credit scoring activities. As will be described herein, in different embodiments some or all of these entities external to user device 102 may receive OTV numbers and/or other user anonymous information described herein to enable secure transactions to occur with limited or no communication of specific user identifying information.

In addition, note that all of these entities (including user device 102) may, in at least certain embodiments provide platforms having one or more secure environments such as the capability for a trusted execution environment, in which transactions may be processed as described herein. In an example embodiment, the TEE may be implemented using Intel® SGX technology, Intel® TXT technology, or an ARM TrustZone, among others. To this end, processors and/or other hardware within such platforms may provide trusted hardware to perform trust assertions, random number generation and other security measures appropriate for given transactions.

By way of illustration, in one example user device 102 may be employed to generate a set of pseudo random numbers as a function of time. As further illustrated in FIG. 1, a wireless interface 110 is present, which may form part of interface 112 in some embodiments. Wireless interface 110 may comprise a component or logic including one or more radios that operate according to known techniques such as one or more wireless communication protocols and/or a global positioning system (GPS) receiver.

This ability to control access provided by entropy multiplexer 104 has advantages in comparison to conventional services that perform transactions through complex access control systems which require identification. In the conventional service scenario, a first user device and second user device may each be configured with agreed upon credentials that allows both to create or access user information in an unfettered manner. However, such information is typically encrypted in order for the user to maintain complete control over user information. Use of traditional encryption hinders sharing different time segments with different recipients by forcing knowledge before-hand of how information will be segmented and shared, or by forcing the provision/exchange of many decryption keys.

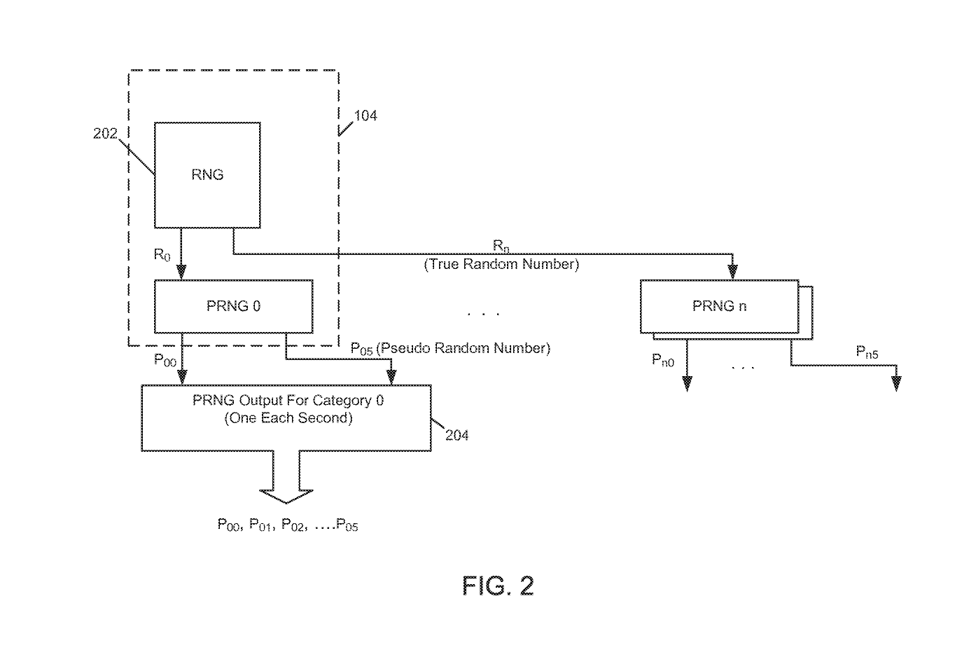

FIG. 2 depicts details of operation of an entropy multiplexer 104 consistent with various embodiments. As illustrated, entropy multiplexer 104 is configured with a random number generator 202 that is configured to generate a random number (RN) to be used for entropy multiplexing. Consistent with the present embodiments the RN generated by entropy multiplexer 104 is employed as a root seed value for a sequence of pseudo random numbers to be generated and associated with a user in a manner that allows the data to be communicated anonymously without encryption. In various embodiments the random number generator may be a digital random number generator such as an Intel ® Digital Random Number Generator (DRNG) or other random number generator. Embodiments are not limited in this context. In one implementation the random number RN generated by entropy multiplexer 104 is used to represent a category such as an account category, a money category, a location category, though the RN may be used for other categories of user information. In other cases a categorical hierarchy may be provided, in which a RN is associated with a given entity type, such as a bank category, which can then be used to generate a set of sub-categories, such as credit, deposit, and so forth. From there, further sub-categories for particular account types, users, and so forth can be realized.

As shown in FIG. 2, random number generator 202 may generate a series of true random numbers shown as R₀ to Rₙ which are used as category seeds from which a random number sequence for a given category of user information may be generated. In one example, R0 may represent a random number seed for a credit card category. In one use scenario, entropy multiplexer 104 may be located in a user device such as a personal computer (PC), from which one or more of the RNs R₀ to R_{N} may be communicated to other user devices including mobile devices. When the random number R₀ is communicated to, e.g., a backend service such as a clearing house, for example, this may enable the service to verify a given OTV value received from device 102 according to Entropy Multiplexing (EM). For example, any service that receives the random number R₀ may employ that random number to generate a pseudo random number sequence via a Pseudo Random Number Generator (PRNG) of the service.

As detailed below the PRNGs are used as a source of digital entropy to anonymize user information. The use of PRNGs as a source of digital entropy as provided by the present embodiments has the advantages of scalability and speed in comparison to systems based, for example, solely on true random number generators. PRNG's also provide the advantage that they produce re-creatable sequences. This allows a receiver of a seed to recreate the numbers associated with that seed in order to find the information that is otherwise hidden through the use of EM. True random numbers do not have a seed and are produced in an unpredictable and unrepeatable fashion. As discussed below, true random numbers may be employed in the present embodiments to generate the first seeds at a highest level of a category tree. However, under that level PRNGs are used to create the anonymized and recoverable numbers, which cannot be accomplished using true random numbers.

In the illustration of FIG. 2, a PRNGO that receives the random number R₀ may be located on a user mobile device or PC and may be used to generate (and regenerate) a Pseudo Random Number (PRN) sequence, each of which may be used to generate an OTV value.

Over time, the user mobile device may periodically generate OTV numbers. For example, PRNGO may generate periodically a set of PRNs P₀₀ to P₀₅ as shown. For example the set of PRNs P₀₀ to P₀₅ may each be associated with a given category for a particular time quantum (e.g., one second as an example). Thus, consistent with various embodiments of the disclosure, in one example an OTV number for a user mobile device can be generated at a given time interval, and used in performing a transaction.

It is to be noted that the PRN in each of a sequence of PRNs is generated based upon a procedure or algorithm implemented by the PRNG such as PRNGO. Each successive PRN is generated by operation of the algorithm on the previous PRN. In order for a trusted party to regenerate a given PRN in a sequence generated by the PRNGO, in addition to the actual algorithm employed by the PRNGO, the party may be provided with a seed used to initialize the PRNGO, as well as the number of steps taken to reach the given PRN from the PRNGO.

Thus, a PRN that is derived from a given PRN may be regenerated by any party or entity that employs a pseudo random number generator using the given algorithm and having the given PRN as input.

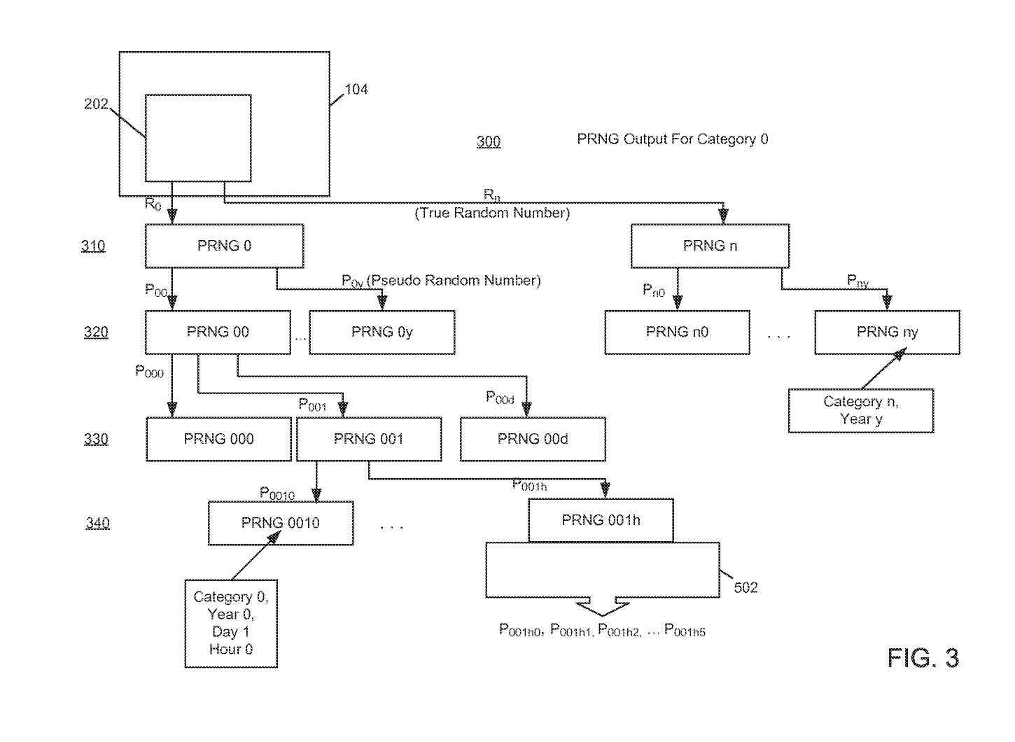

In various additional embodiments, EM may be used to time-bound use of an OTV number, meaning to restrict access within a time window. In particular, an architecture referred to herein as a “PRNG tree” may be used as the basis of a PRN-generation algorithm such that a user is provided with the ability to perform a transaction with an OTV number for a certain time quantum. In these additional embodiments, time bounded OTV values may be used in a manner that preserves user anonymity as generally described in the aforementioned embodiments. FIG. 3 depicts an architecture 300 that is arranged in a seed encoding tree structure having a series of levels 310, 320, 330, 340 that each have one or more PRNGs. Note that in other cases, a single PRNG can be used to generate seeds and then be re-seeded to generate further seeds and portions of a different tree structures. At upper category level 310 a series of categories are defined by the true random number seeds RO to Rn which are sent from random number generator 202 to respective pseudo random number generators PRNGO to PRNGn. Each category may represent an isolated context such as a credit account, credit score or so forth. As illustrated, the PRNG tree structure is such that a random number seed generated for a given level is operative to seed one or more random number sequences at levels below the given level. This may result in generation of multiple parallel random number sequences populated as the random number generation extends to lower levels in which each given random number of a random number sequence received from a higher level may feed a separate PRNG at a level below. Each separate PRNG, in turn, may generate a new random number sequence in which each random number feeds a corresponding PRNG on a lower level.

In the example of FIG. 3, the random number seeds act as category keys in which under a given category key, there exists a PRNG that is seeded by the category key, which produces new PRNs representing a given level in a time quantum hierarchy. In the example of FIG. 3, PRNGO generates a PRN such as P 00 . . . P 0Y to the respective yearly pseudo random number generators PRNG00 . . . PRNG0y at yearly level 320. Each yearly PRN in turn feeds another nested PRNG located at a level below. As shown, the yearly PRNG00 generates the sequence P000, P001 . . . P00d, . . . which are fed to respective daily PRNG000, PRNG001, . . . PRNG00d located at a daily level 330. As illustrated for one daily PRNG the daily PRNG001 generates the sequence P 0010 . . . P 001h which are received by respective hourly PRNGs. P0010 . . . P001h at hourly level 340. Although not shown, further levels below level 340 which represent shorter time intervals are possible in various embodiments. The nesting process thus continues down to cover shorter and shorter time intervals until PRNs that represent a most frequent sample rate are issued, which may be the desired sample rate for generated OTV numbers.

In the tree structure provided by the architecture 300, on one or more levels multiple PRNGs may be deployed according to the number of timing entities that are provided within that level. For example, on daily level 330 up to 365 PRNGs may be provided for each day of a year. On the hourly level 340 up to 24 PRNGs may be provided for each hour of a day. However, more or fewer PRNGs than 24 may be provided on the hourly level 340 and more or fewer than 365 PRNGs may be provided on daily level 330.

When a trusted party is to be granted access to time-bound user information, a user device may receive the information, such as a given hour in a given day, and associate the time-bound user information with the appropriate PRN of the PRNG tree for that hour. Although in various embodiments the PRNGs of the PRNG tree structure of FIG. 3 may all be the same, that is, may all employ the same PRNG algorithm, in other embodiments, different PRNGs may employ different PRNG algorithms. This may provide a user with another level of control over access to user information. The specifics of which PRNG algorithm, which random number seed, and when the new PRNG are to be deployed may be included, or may be communicated via an out of-band channel between entities.

While the aforementioned embodiments that employ EM to communicate OTV numbers do not use encryption to protect a user's identity from unwanted uses, encryption procedures themselves may be integrated into a PRNG architecture similar to that disclosed above. In particular, the PRNG architecture of an EM system may be extended by creating an additional type of PRNG to manage anonymization of encryption information.

Embodiments may be applied to many different use cases for handling transactions securely. As one example use case, assume a user Alice wants to share a one-time virtual (OTV) (or equally one-time value) credit card number with a retailer. First, a random number can be generated (e.g., using a DRNG hardware logic of a processor) that represents Alice's seed. As one example, the DRNG hardware can generate a 256-bit RN, resulting in 2²⁵⁶ possibilities. Note that in some cases, this RN may be received in the system from an external entity. Next, a PRNG (e.g., also present in a processor of Alice's system) is used to generate a PRN sequence that is used to create a PRN tree. Note that in actuality, “generation” or “creation” of a PRN tree is not possible, as such tree is an infinitely large and expanding structure. Instead, as used herein these terms relate to generation of time-delimited branches of such trees and/or a portion of a tree structure associated with a given time bounding.

A leaf PRN may be used to generate multiple OTV numbers. In different embodiments, these OTV numbers can be virtual credit cards or other account identifiers. During a transaction, the system provides certain information including an assertion regarding a schema associated with the OTV (such as information of the time quantum level being encoded and so forth) and a seed corresponding to the PRN sub-tree, e.g., to a merchant, which in turn provides to a payment clearing house such as Apple Pay™, Google Wallet™, etc., to enable the transaction to be cleared. Note that in other cases, where parties have agreed in advance to an encoding scheme, this assertion and related metadata can be implied and simply transaction details and seed may be transmitted.

In different embodiments, this seed may be transmitted in an encrypted or clear form and/or via an out-of-band channel. Using the seed for the PRNG, the payment clearing house can re-generate the PRN sequence to retrieve the OTV credit card value Alice originally created. More specifically, the clearing house knows which branch of the PRN tree to use by associating branches of the tree with a single-use encoding scheme such as a decomposition of date/time, where larger time quanta are at the root and fine grain quanta are nearer the leaves.

Note that in this scenario, even though Alice generated a time-bound one-time card number with STEEM, Alice may be able to selectively allow a merchant to refund all or a portion of a transaction amount post expiry of the virtual card, by generation of the appropriate encoded PRNG seed sequence based on the transaction date. Since the current date exceeds the transaction date, the OTV is no longer authorized for new transactions, but it may be allowed to be used for performing a refund transaction.

Embodiments enable a user device to provide one or more seed values (in clear or encrypted format) from a PRNG seed tree to enable third parties such as a point of sale (POS) terminal or payment clearing house to access one or more time bound sequences of credit information from the past, present or future. Embodiments may further providing an ability to access past information, to enable a merchant to credit back a return post the expiry of virtual credit card.

Also, by sharing only the seed values of the PRNG tree, user anonymity may be preserved because no user metadata is shared as part of the transaction, and the seed information is highly entropic. As such, malicious users cannot correlate the seed information with external databases or privacy sensitive user metadata because the OTV value may be only used once. As will be described herein, a hierarchy of PRNG seed trees can be generated for fine granular details and a time-bound sequence can be shared appropriately. For example, based on the seed tree, a lender can ascertain a credit history of a person for given time frame/geographic location without having a user disclose sensitive information. In addition, acquiring banks can dynamically manage account credit limits using credit score information, even when the account is associated with an anonymous user, joint account or a business/enterprise account.

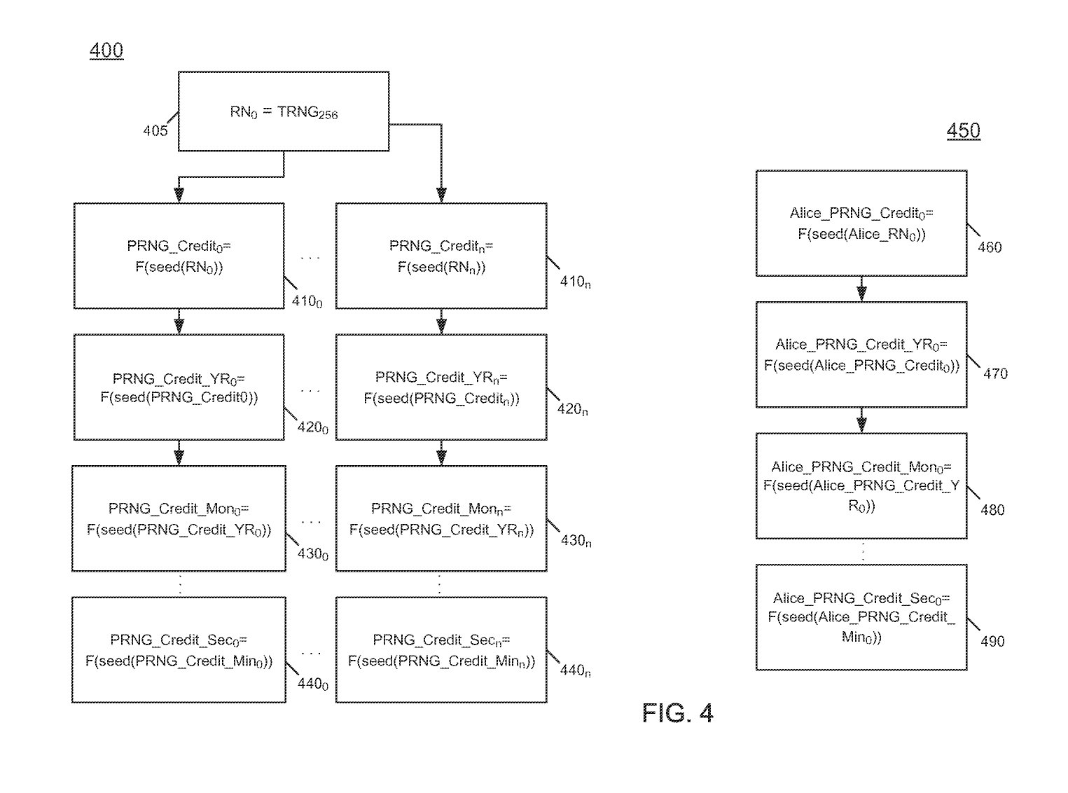

Referring now to FIG. 4, shown is a block diagram of an encoding of an OTV credit card number based on a date/time PRN tree correlation. As shown in FIG. 4, a set of pseudo random number trees can be generated in a user system 400. More specifically, based on a true random number 405, one or more pseudo random number trees 410₀-410ₙ can be generated. In an embodiment, the random number RN₀ may be a true random number of a 2²⁵⁶ width. This random number may be generated in a digital random number generator of system 400 or in other cases may be received within the system from a remote entity. As illustrated in FIG. 4, this single random number can be used to generate multiple sequences, including a first PRN seed 410. This first level seed 410 may correspond to a particular category. For example, this category may be a credit category, with each tree associated with a particular user account, where different levels of the PRN trees can be used as OTV values (or equally used to generate an OTV number therefrom). Note that this latter approach may be used to allow an application to use different OTVs for different but related purposes. For example assume a user has multiple bank accounts, where each account uses a different OTV for the same time quantum.

In the encoding shown in FIG. 4, each level below first PRN seed 410 may be associated with a particular time quantum. In the specific embodiments shown, level 420 may associated with a year, level 430 associated with a month, and level 440 associated with a second. Understand while shown with these particular time quanta, more levels and/or different quanta can be present in other embodiments. Note that in turn, each level below first PRN seed 410₀ may be generated in turn from the above level's seed value. As such, a month value can be generated using a year seed value, a day value (not shown) can be generated using the month seed value, and so forth, e.g., all the way to (but not limited to) a seconds level 440.

FIG. 4 in addition shows a remote entity 450 such as a server computer associated with a remote entity, such as a clearing house, which may receive a corresponding first seed value associated with a particular user and generate a corresponding PRN tree therefrom, which may be a computed tree having levels 460, 470, 480 and 490 based on this first received seed value to enable comparison operations to thereafter be performed to verify a value received with a transaction occurring at a given time. Understand while shown at this high level in the embodiment of FIG. 4, many variations and alternatives are possible.

Thus a user and a transaction clearing house may share a seed that roots the tree. The clearing house may obtain a sub-tree root seed value from a user's acquiring bank. The acquiring bank may opt to limit the user's use of the clearing house in this way. As such, the acquiring bank can revoke/close an account by allowing it to expire on a pre-determined date (e.g., by not providing a root seed, but instead sending a sub-node seed representing a time-limited bound).

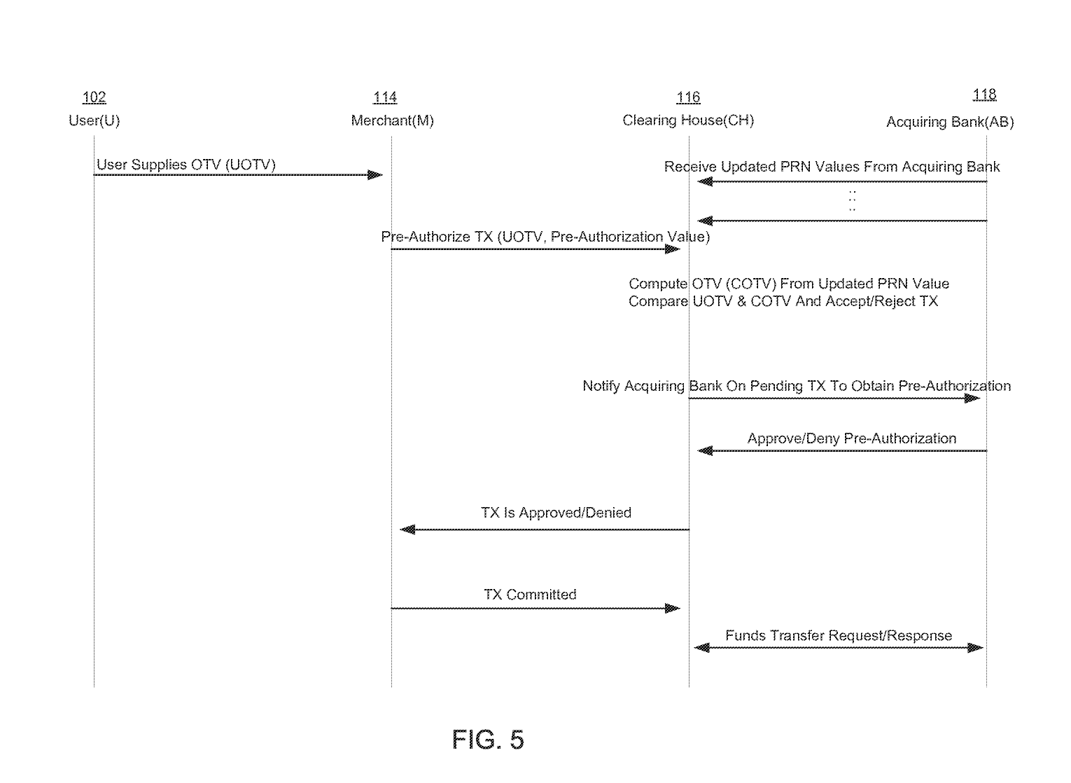

Referring now to FIG. 5, shown is an example transaction flow using an OTV in accordance with an embodiment. In the embodiment of FIG. 5, an environment is present in which various remote entities, each having one or more computing devices can interact in enabling a transaction to be performed between a user 102 and a merchant 114. In different cases, user 102 may perform a transaction using a smartphone, tablet computer, desktop computer or so forth, and which may be in communication with a system of merchant 114, such as a point of sale system. In turn, merchant 114 may communicate with a backend clearing house 116 which may have one or more server computers configured to clear transactions for one or more merchants (and which maintain association of particular banks and certain RNs or high level PRNs). In turn, clearing house 116 may be in communication with an acquiring bank 118 which may have one or more server computers configured to be the ultimate arbiter as to whether to allow a particular transaction to occur based on, e.g., user account information, a value of the transaction (as represented by a pre-authorization value) among other such information.

As shown, the user supplies an OTV to the merchant, and the merchant pre-authorizes transaction by sending the OTV and a pre-authorization value to the CH. The CH may receive updated PRN tree values from various acquiring banks (ABs); the OTVs for each user for that time quanta (second, minute, etc.) can be computed. Note that the double lines (and ellipsis in between) in FIG. 5 for such updated PRN tree values indicate that the CH may receive such updates any time before pre-authorization of a transaction. The CH compares the received user OTV (UOTV) with each computed OTV (COTV). When the UOTV matches a COTV a transaction can be cleared. The CH notifies the AB of a pending transaction to obtain pre-authorization, and then informs the merchant. The merchant completes the transaction (or aborts). If completed, the CH processes the transfer of funds using the actual transaction amount with OTV.

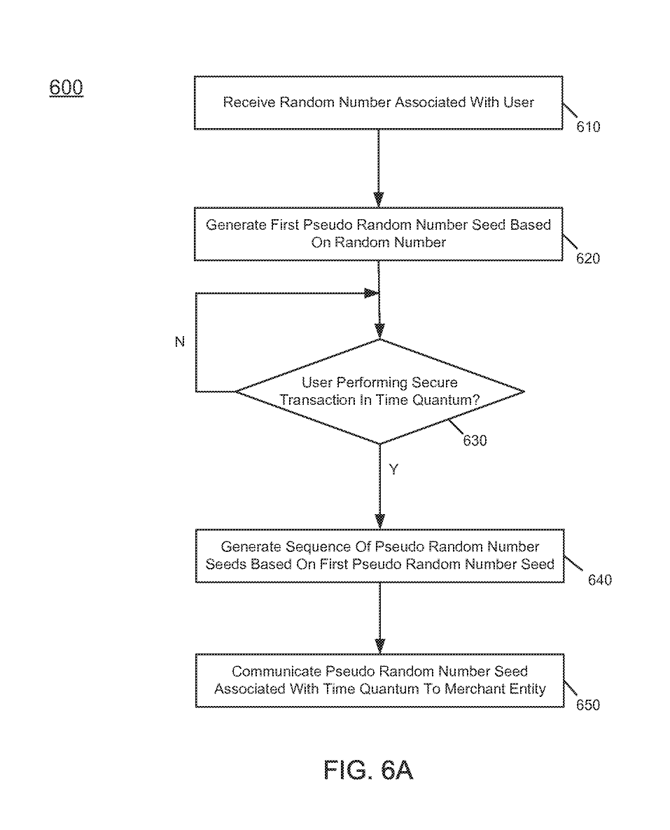

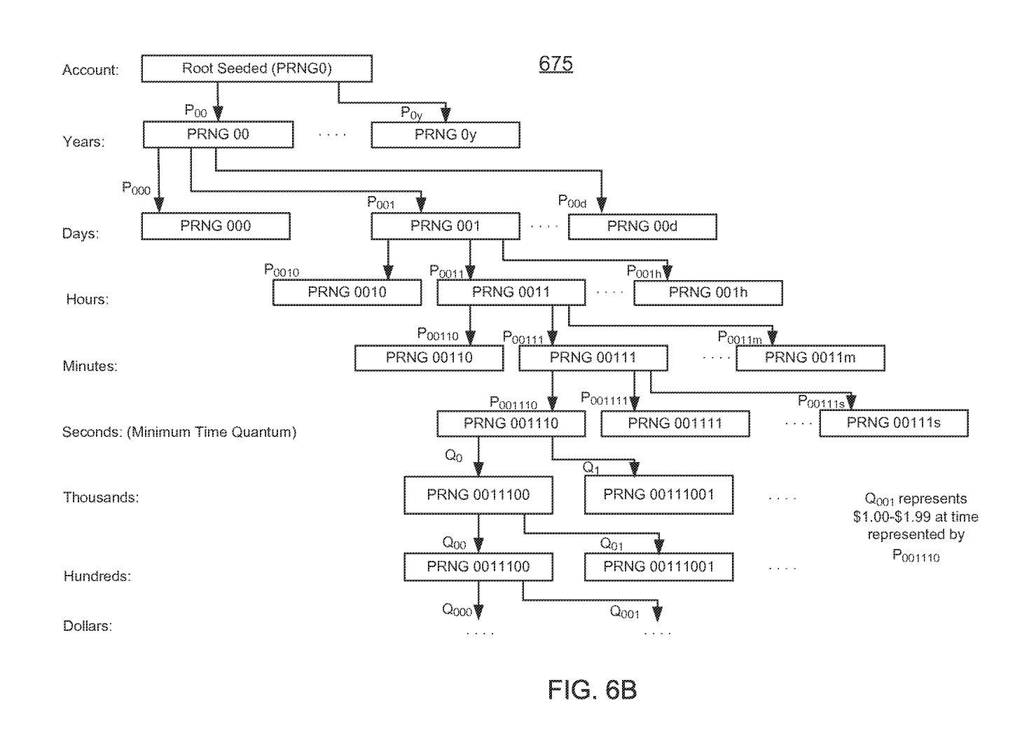

Referring now to FIG. 6A, shown is a flow diagram of a method in accordance with an embodiment of the present invention. As shown in FIG. 6A, method 600 may be performed by combinations of hardware, software, and/or firmware, such as security hardware logic within one or more systems configured to enable secure transactions to be performed in a user anonymous manner such that user identifying information need not be communicated between parties to the transaction. As illustrated, method 600 begins by receiving a random number associated with a user (block 610). In an embodiment, this random number may be a true random number received in a system of the user (e.g., a desktop computer, laptop computer, tablet computer, smartphone or so forth). As an example, such random number may be provided by an acquiring bank with which the user has an account. Of course in other cases, this received random number may be generated in the user system itself, e.g., by an Intel® Digital Random Number Generator, which may be a time-delimited value.

Still with reference to FIG. 6A, next a first pseudo random number seed may be generated based on this random number (block 620). This first pseudo random number seed may be a pseudo random number seed for a given category, such as a credit category. At diamond 630, it can be determined whether the user is performing a secure transaction in a particular time quantum. Note that the granularity of the time quantum can vary in embodiments, and can range from day, hour, minute, second or so forth. If such transaction is being performed, such as where a user is performing an online transaction with a remote merchant, control passes thereafter to block 640, where a sequence of pseudo random number seeds may be generated based on the first pseudo random number seed (block 640). As such, a pseudo random number tree can be generated. As one example, each level of the tree may be associated with a given time quantum (e.g., starting with year and proceeding through some or all of month, day, hour, minute, second, or so forth).

After the pseudo random tree is generated, control passes to block 650 where a pseudo random number seed associated with the time quantum can be communicated to the merchant entity. As described herein, this pseudo random number seed can in turn be provided from the merchant entity to, e.g., a clearing house to enable a determination to be made as to whether the transaction is allowed to be performed. Understand while shown at this high level in the embodiment of FIG. 6A, many variations and alternatives are possible. For example, in other cases, an amount OTV value can be generated, e.g., as a sub-node from a given transaction's OTV value such that the two OTV values for a transaction can represent, respectively, a time quantum and a transaction amount (or range). In another embodiment, two OTV values can be generated for a transaction, with the first value representing a first time and transaction amount (e.g., a valid start time and minimum amount) and the second value representing a second time and transaction amount (e.g., a valid end time and maximum amount). In a still other embodiment, a single OTV can be used to represent both time quantum and money quantum (e.g., Q001 in FIG. 6B, discussed below). This is so, as one cannot generate Q001 without it being tied to the specific time quantum, which proves that the bearer of Q001 received its information from someone having the PRN associated with the specific time quantum.

Referring now to FIG. 6B, shown is a tree structure that encodes both time and transaction amount in accordance with an embodiment of the present invention. As shown in FIG. 6B, a tree structure 675 includes time levels extending to a minimum time quantum (e.g., seconds). From these values, as seeds, corresponding transaction amounts can be encoded in sub-nodes of tree structure 675. Note that knowing the time quantum P001110 provides an unlimited transaction amount, while knowing Q0 provides access to $0-$999.99 and knowing Q000 provides access to $0-0.99. If an assertion is made that an amount of between $1.00 and $1.99 is being spent at the time quantum represented by P001110, presentation of Q001 can prove the assertion and allow a clearing house with knowledge of P001110 (or P00111, P0011, P001, P00, or the root seed) to verify the transaction.

For a more complex transaction, one could present two assertions (first assertion: minimum time and minimum amount, second assertion: maximum time and maximum amount) and two OTV's to bound the transaction across both time and amount. In this case, the bearer of the transaction (a merchant who needs to add a tip sometime in the next hour, for example) can make a third assertion that lies within the time and amount bounds. The CH can use the first two assertions and two OTV's to identify the account and pre-authorize the upper amount or include the third assertion too in order handle a specific amount at a specified time. Note that a third OTV need not be provided if the third assertion lies within the bounds of the first two assertions, and those assertions prove true using the two OTV's.

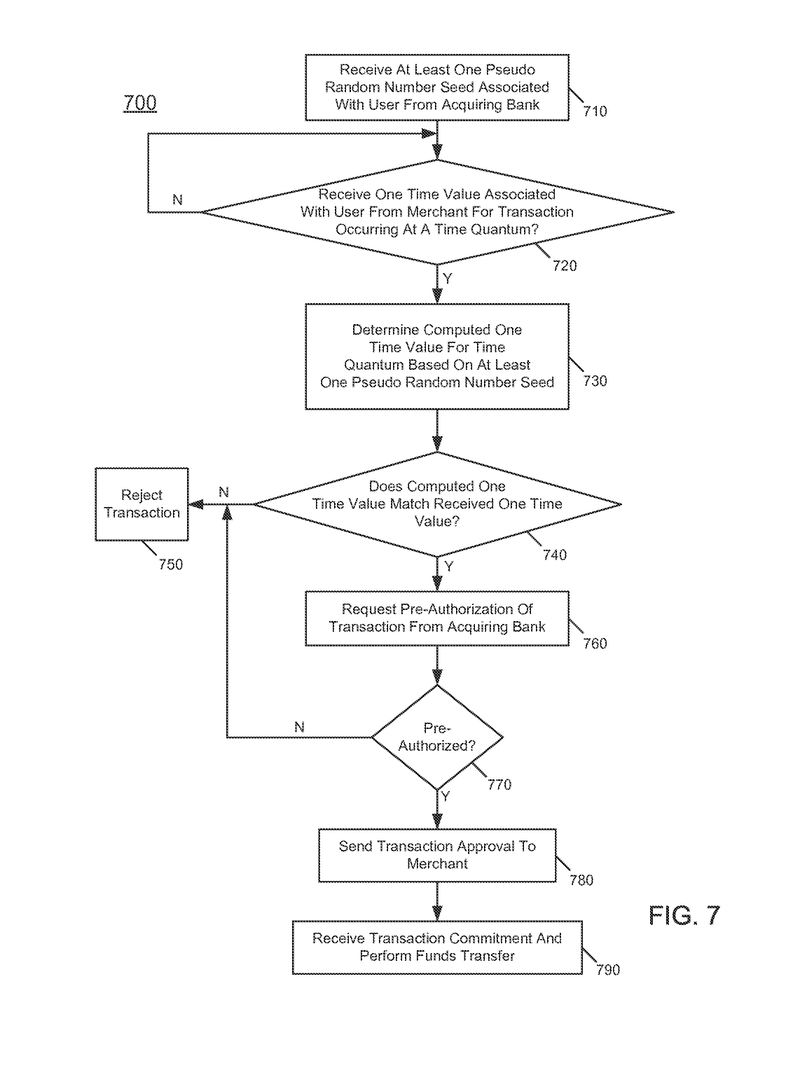

Referring now to FIG. 7, shown is a flow diagram of a method for handling an incoming transaction from a clearing house point of view in accordance with an embodiment. As such, method 700 may be performed by one or more server computers associated with a clearing house. In an embodiment, such computers may be configured with combinations of hardware, software, and/or firmware to perform these operations. In an embodiment, security hardware logic of such systems available in a trusted execution environment may perform the methods, at least in part. As seen, method 700 begins by receiving at least one pseudo random number seed associated with a user from an acquiring bank (block 710). Such pseudo random number seed may be associated with a particular time quantum, such as a duration of a month, year or another time duration. Such pseudo random number seed may be stored in a secure storage, e.g., associated with a record for the user.

Thereafter, at diamond 720 it can be determined whether a one time value associated with the user is received from a merchant for a transaction occurring at a particular time domain. In an embodiment, this determination may be based at least in part on calculations performed on this one time value, as the one time value can be received in a user anonymous manner. Thus as shown in FIG. 7, a calculated one time value can be calculated for the time quantum based on the at least one pseudo random number seed. Note that to effect this determination, the logic may perform such calculations for a number of received pseudo random number seeds to determine whether any such calculated one time values match the received one time value.

If it is determined at diamond 740 that the computed one time value matches the received one time value, control passes to block 760 where the clearing house may request a preauthorization for the transaction from an acquiring bank. Based on an indication received from this acquiring bank it can be determined whether the transaction is pre-authorized (diamond 770). If so, control passes to block 780 where a transaction approval can be sent to the merchant. Thereafter, an indication from the merchant may be received regarding commitment of the transaction. At this point, the clearing house, alone or in connection with the acquiring bank may perform a funds transfer to thus transfer an amount of funds associated with the transaction from an account of the user to the merchant (block 790). Note that from either of diamond 740 and 770, if the determination is in a negative, the transaction is rejected (block 750), and a corresponding rejection message may be sent from the clearing house to the merchant to thus prevent the transaction from occurring. Understand while shown at this high level in the embodiment of FIG. 7, many variations and alternatives are possible.

Note that the seed trees disclosed herein may be used to encode a credit score PRN tree where a credit scoring provider (CSP), such as a credit bureau, e.g., Experian, Equifax or so forth, establishes a PRN tree for participating users. In such cases, the CSP accepts credit events from acquiring banks for each of their customers. The CSP shares a PRN value with each user. In turn, the user generates a credit score transaction code (CSTC) that is included with transaction data of a particular transaction. If an acquiring bank determines a credit scoring event has occurred, the acquiring bank may update the CSP with the CSTC value and other event data. In return, the acquiring bank may obtain a current (and possibly updated) credit score for the transaction. Note that this CSTC value does not reveal privacy sensitive information about the user because it is entropic and one-time use. The CSP correlates the CSTC by searching a list of CSTC values it has generated for its customer base for the associated transaction. If a credit score is raised/lowered due to CSTC activity, the next acquiring bank that processes a transaction can obtain the updated score. If the user withholds the CSTC, the acquiring bank may supply event data using the user identity information it has on file. However, if the user wishing to remain anonymous does not supply this information or if the account at the acquiring bank is a joint or business account, then this approach may not be applicable. Users are motivated to include CSTC values in connection with transactions so that credit score values may improve even when acquiring banks host accounts that do not provide for update of a specific user's credit score.

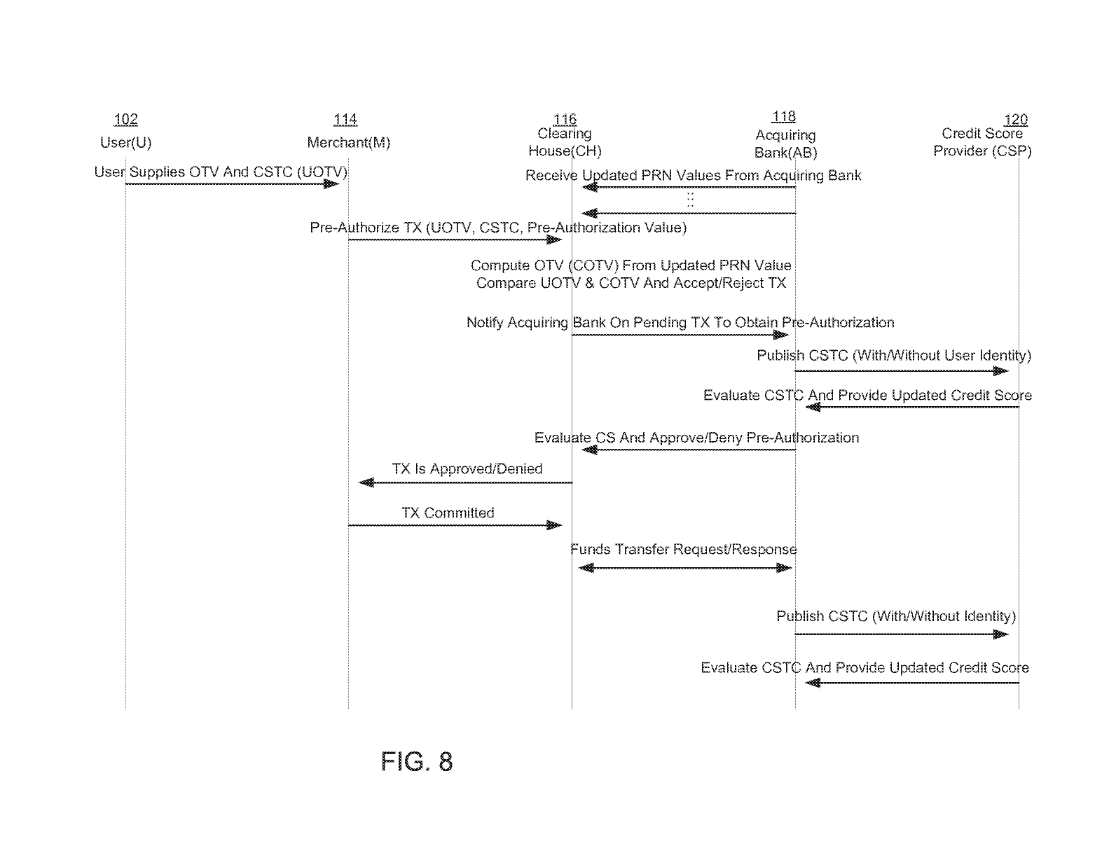

Referring now to FIG. 8, shown is an example transaction flow for a transaction clearing process in accordance with another embodiment in which credit scoring information is included. As seen in FIG. 8, an additional credit scoring provider 120 (which may have one or more server computers) is present in the environment with the other entities of FIG. 5. In this case, the user supplies an OTV and CSTC to the merchant. In turn, the merchant pre-authorizes the transaction by sending the OTV, CSTC and pre-authorization value to the CH. The CH may receive updated PRN tree values from various acquiring banks and the OTVs for each user for that time quanta (second, minute etc.) are computed. The CH compares the received user OTV (UOTV) with each computed OTV (COTV). When the UOTV matches a COTV, a transaction can be cleared. In turn, the CH notifies the AB of a pending transaction to obtain pre-authorization. The AB sends credit event data to the CSP using the CSTC (or optionally user identifying information if available). The CSP evaluates and updates the credit score. This updated credit score is returned to the AB. The AB may increase/decrease credit limits on the user account in response, and the AB returns pre-authorization approval/denial as appropriate. The merchant completes the transaction (or aborts). If completed, the CH processes the transfer of funds using the actual transaction amount using the OTV and CSTC. The AB may again update the credit score after transaction clears using the CSTC as described above.

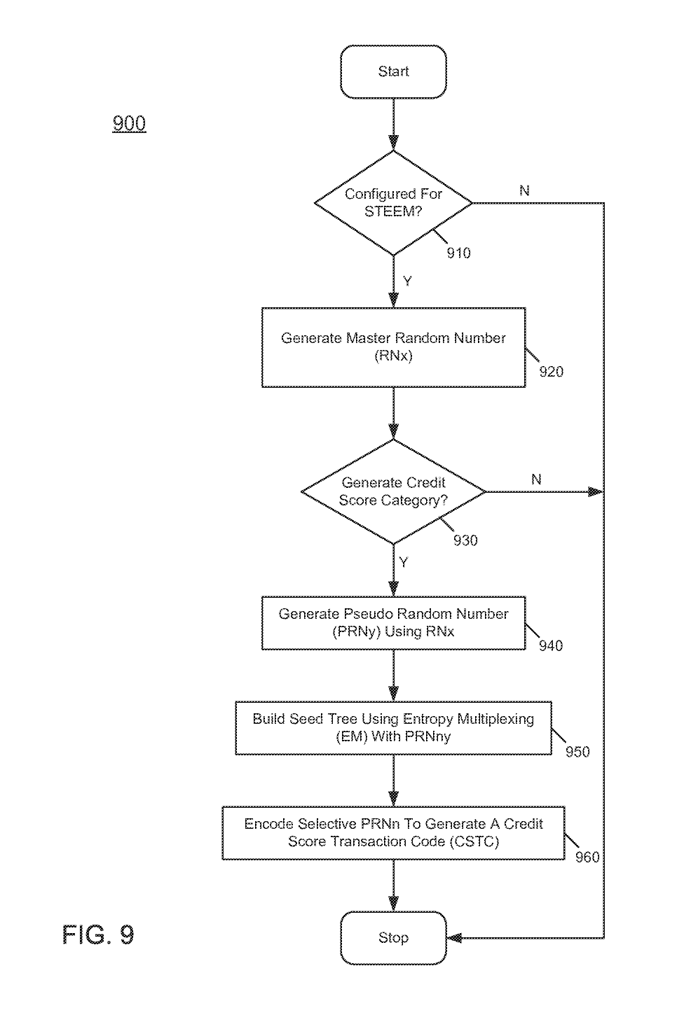

Referring now to FIG. 9, shown is a flow diagram of a method for generating a credit score transaction code (CSTC) in a user device in accordance with an embodiment. As such, method 900 may be performed by appropriate combinations of hardware, software, and/or firmware of a user device. Such combinations may include a credit hardware logic of the system. As seen, method 900 begins by determining whether the system is implemented to perform seed tree encoding using an entropy multiplexer as described herein. If so, control passes to block 920 where a master random number may be generated. In an embodiment, this master random number may be generated using an Intel® Digital Random Number Generator. Next it is determined whether a credit category is to be generated (diamond 930). If so, at block 940 a first pseudo random number seed is generated using the random number. Thereafter at block 950 an appropriate seed tree may be generated using entropy multiplexing with this first pseudo random number. At block 960 a CSTC may be generated by encoding a selective one of the pseudo random number values (such as by specifying a schema, encryption key identifier and so forth) to thus appropriately encode the CSTC.

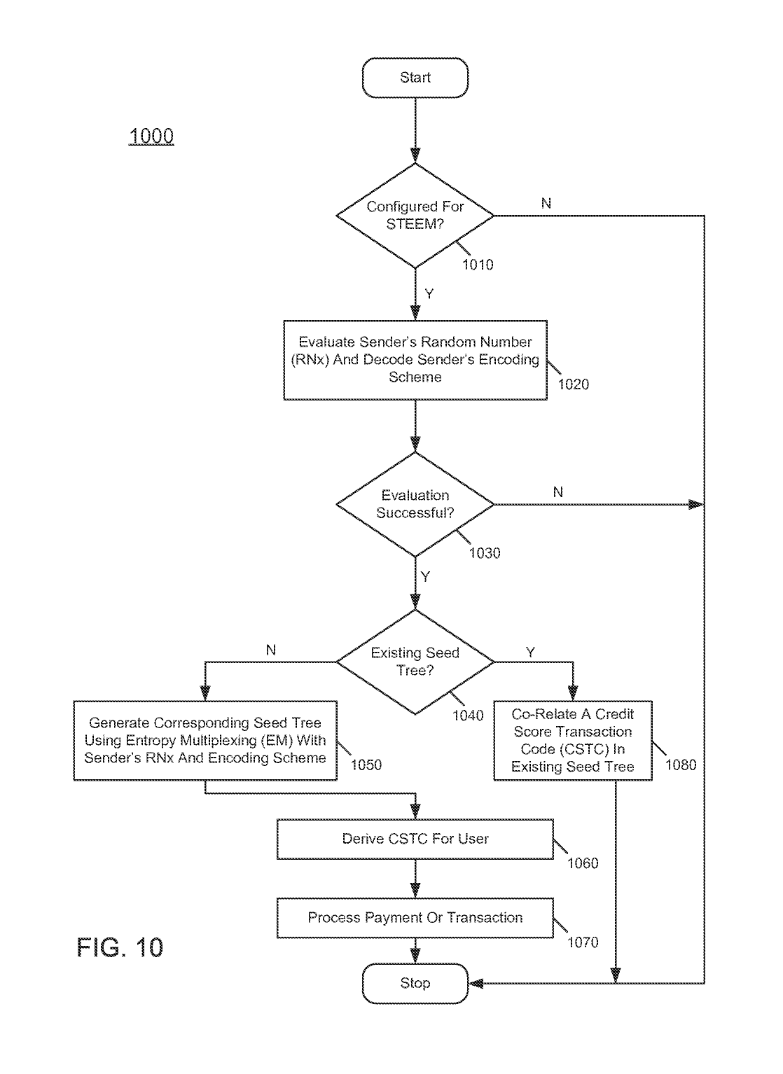

Referring now to FIG. 10, shown is a flow diagram of a method for generating a credit score transaction code at a credit service provider in accordance with an embodiment. As shown in FIG. 10, method 1000 may be performed by appropriate combinations of hardware, software, and/or firmware of the credit service provider. Such combinations may include a credit hardware logic of the system.

At diamond 1010, it can be determined whether the system is implemented to perform seed tree encoding using an entropy multiplexer as described herein. If so, control passes to block 1020, where a sender's random number (which can be sent from a user itself or an intermediary between the user and the credit score provider) can be evaluated. More specifically, the sender's encoding scheme can be decoded using a specified tree depth, encryption mode, key identifier or so forth. If it is determined that the evaluation is successful (at diamond 1030) next it can be determined whether an existing seed tree is present in the credit score provider (diamond 1040). If so, the CSTC may be co-related in the existing seed tree (block 1080). Thereafter, this value can be used in comparisons with computed values, as described herein. For example, a CSTC correlation may be used to instruct a payment processor (e.g., at block 1070) to adjust a payment instrument dynamically to account for elevated/reduced risk based on credit score value. A per-transaction credit rating may result in a per-transaction daily rate calculation. Similar to the way credit vendors charge a different rate for cash advances than for purchases, the credit score code may be used to code an interest rate per purchase.

Otherwise, if no existing seed tree is present as determined at diamond 1040, control passes to block 1050 where a corresponding seed tree may be generated. More specifically, this seed tree may be generated using entropy multiplexing as described herein based on the sender's random number and corresponding encoding scheme. This seed tree may be used to generate an OTV credit card number, as the CSTC authorizes the payment infrastructure to generate transaction per-approval and to authorize funds transfer. Thereafter at block 1060 an appropriate CSTC for the user may be derived. Thereafter a payment or transaction may be processed (block 1070). For example, a credit check may be performed, or a credit or debit transaction may be handled. Understand while shown at this high level in the embodiment of FIG. 10, many variations and alternatives are possible.

Thus in various embodiments a STEEM methodology can generate a seed tree hierarchy to share a sensitive data sequence in the past, present or future. With such techniques, credit scores can be used to dynamically adjust account credit limits. In addition, CSTCs as described herein can be used to allow dynamic credit scoring even for anonymous, joint and business/enterprise accounts. Still further, embodiments enable anonymous transaction clearing using a STEEM methodology as described herein.

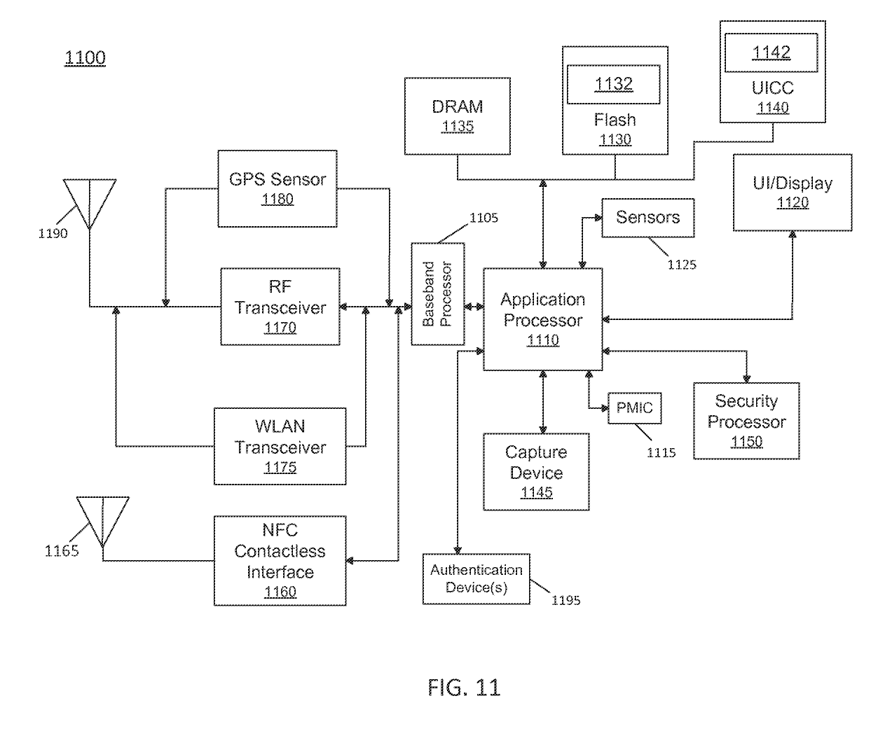

Referring now to FIG. 11, shown is a block diagram of an example system with which embodiments can be used. As seen, system 1100 may be a smartphone or other wireless communicator, on which a user seeks to perform a transaction such as via near field interaction with a point-of-sale system, e.g., of a retailer. A baseband processor 1105 is configured to perform various signal processing with regard to communication signals to be transmitted from or received by the system. In turn, baseband processor 1105 is coupled to an application processor 1110, which may be a main CPU of the system to execute an OS and other system software, in addition to user applications such as many well-known social media and multimedia apps. Application processor 1110 may further be configured to perform a variety of other computing operations for the device. Application processor 1110 may be configured with one or more trusted execution environments to perform embodiments described herein.

Application processor 1110 can couple to a user interface/display 1120, e.g., a touch screen display. In addition, application processor 1110 may couple to a memory system including a non-volatile memory, namely a flash memory 1130 and a system memory, namely a DRAM 1135. In some embodiments, flash memory 1130 may include a secure portion 1132 in which sensitive information (including one or more RNs or other seed values as described herein) may be stored. As further seen, application processor 1110 also couples to a capture device 1145 such as one or more image capture devices that can record video and/or still images.

Still referring to FIG. 11, a universal integrated circuit card (UICC) 1140 comprising a subscriber identity module, which in some embodiments includes a secure storage 1142 to store secure user information. System 1100 may further include a security processor 1150 that may couple to application processor 1110. In various embodiments, at least portions of the one or more trusted execution environments and their use may be realized via security processor 1150. A plurality of sensors 1125 may couple to application processor 1110 to enable input of a variety of sensed information such as accelerometer and other environmental information. In addition, one or more authentication devices 1195 may be used to receive, e.g., user biometric input for use in authentication operations.

As further illustrated, a near field communication (NFC) contactless interface 1160 is provided that communicates in a NFC near field via an NFC antenna 1165. While separate antennae are shown in FIG. 11, understand that in some implementations one antenna or a different set of antennae may be provided to enable various wireless functionality.

A power management integrated circuit (PMIC) 1115 couples to application processor 1110 to perform platform level power management. To this end, PMIC 1115 may issue power management requests to application processor 1110 to enter certain low power states as desired. Furthermore, based on platform constraints, PMIC 1115 may also control the power level of other components of system 1100.

To enable communications to be transmitted and received, various circuitry may be coupled between baseband processor 1105 and an antenna 1190. Specifically, a radio frequency (RF) transceiver 1170 and a wireless local area network (WLAN) transceiver 1175 may be present. In general, RF transceiver 1170 may be used to receive and transmit wireless data and calls according to a given wireless communication protocol such as 3G or 4G wireless communication protocol such as in accordance with a code division multiple access (CDMA), global system for mobile communication (GSM), long term evolution (LTE) or other protocol. In addition a GPS sensor 1180 may be present, with location information being provided to security processor 1150 for use as described herein. Other wireless communications such as receipt or transmission of radio signals, e.g., AM/FM and other signals may also be provided. In addition, via WLAN transceiver 1175, local wireless communications, such as according to a Bluetooth™ or IEEE 802.11 standard can also be realized. While not shown for ease of illustration, system 1100 may additionally include a real-time clock (RTC) component, which may be periodically updated through communication with a network time server (NTP) server. In different embodiments, the RTC may be implemented in hardware and/or software.

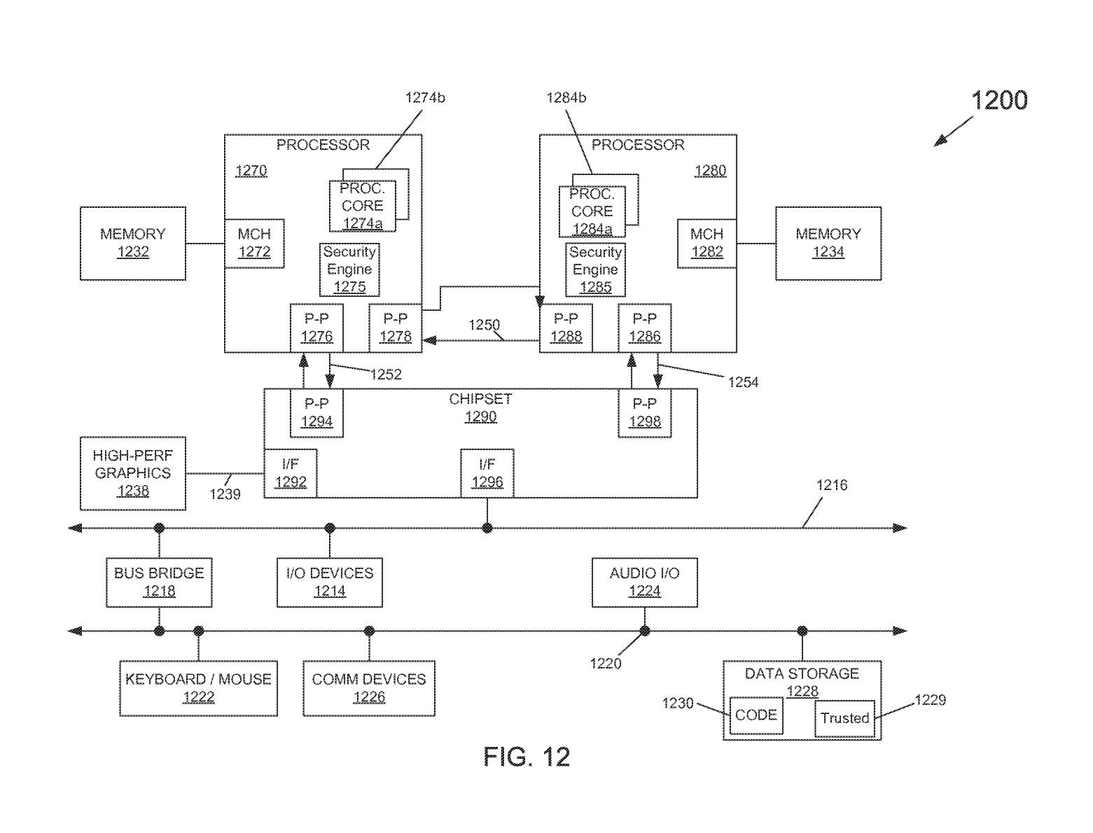

Referring now to FIG. 12, shown is a block diagram of a system in accordance with another embodiment of the present invention. As shown in FIG. 12, multiprocessor system 1200, which may be a server of a clearing house, CSP, AB or other financial entity, is a point-to-point interconnect system, and includes a first processor 1270 and a second processor 1280 coupled via a point-to-point interconnect 1250. As shown in FIG. 12, each of processors 1270 and 1280 may be multicore processors such as SoCs, including first and second processor cores (i.e., processor cores 1274a and 1274b and processor cores 1284a and 1284b), although potentially many more cores may be present in the processors. In addition, processors 1270 and 1280 each may include a security engine 1275 and 1285 to create a TEE and to perform at least portions of the credit and transaction processing using OTV values described herein.

Still referring to FIG. 12, first processor 1270 further includes a memory controller hub (MCH) 1272 and point-to-point (P-P) interfaces 1276 and 1278. Similarly, second processor 1280 includes a MCH 1282 and P-P interfaces 1286 and 1288. As shown in FIG. 11, MCH's 1272 and 1282 couple the processors to respective memories, namely a memory 1232 and a memory 1234, which may be portions of main memory (e.g., a DRAM) locally attached to the respective processors. First processor 1270 and second processor 1280 may be coupled to a chipset 1290 via P-P interconnects 1252 and 1254, respectively. As shown in FIG. 11, chipset 1290 includes P-P interfaces 1294 and 1298.

Furthermore, chipset 1290 includes an interface 1292 to couple chipset 1290 with a high performance graphics engine 1238, by a P-P interconnect 1239. In turn, chipset 1290 may be coupled to a first bus 1216 via an interface 1296. As shown in FIG. 12, various input/output (I/O) devices 1214 may be coupled to first bus 1216, along with a bus bridge 1218 which couples first bus 1216 to a second bus 1220. Various devices may be coupled to second bus 1220 including, for example, a keyboard/mouse 1222, communication devices 1226 and a data storage unit 1228 such as a non-volatile storage or other mass storage device which may include code 1230, in one embodiment. As further seen, data storage unit 1228 also includes a trusted storage 1229 to store, among other information, one or more RNs or other seed values. Further, an audio I/O 1224 may be coupled to second bus 1220. System 1200 may further include a real-time clock as discussed above.

The following examples pertain to further embodiments.

In Example 1, a processor comprises: a first logic to receive a random number associated with a user of a first computing system, generate a first pseudo random number seed based on the random number, the first pseudo random number seed associated with a first account of the user, and generate a sequence of pseudo random number seeds based on the first pseudo random number seed, where a first leaf of the sequence of pseudo random number seeds comprises a one time value associated with the first account; and a communication logic to communicate the one time value to a second computing system associated with a merchant, where a credit entity is to authorize a transaction occurring at a first time quantum based at least in part on the one time value.

In Example 2, the communication logic is to communicate the one time value without user identifying information.

In Example 3, the random number is to be shared with the credit entity, and the credit entity is to generate a computed one time value based thereon and authorize the transaction if the computed one time value matches the one time value.

In Example 4, the one time value comprises a virtual credit card.

In Example 5, the first logic of Example 1 comprises an entropy multiplexer comprising one or more PRNGs, each pseudo random number generator to generate a sequence of one or more pseudo random numbers based upon a pseudo random number seed.

In Example 6, the entropy multiplexer comprises a random number generator tree having a plurality of levels to generate one or more random numbers at each level of the plurality of levels, where a first random number generated by a first random number generator on a first level is to feed a second random number generator on a second level lower than the first level, the second random number generator to generate a random number sequence comprising two or more random numbers.

In Example 7, the first level includes a multiplicity of random number generators fed by a corresponding multiplicity of first random number seeds, the first random number seeds to be generated for a first time quantum, and the second level includes a multiplicity of random number generators fed by a corresponding multiplicity of second random number seeds, the second random number seeds to be generated for a second time quantum smaller than the first time quantum.

In Example 8, each of the plurality of levels is associated with a different time quantum, and the one time value is associated with the first time quantum of the transaction.

In Example 9, the communication logic of one or more of the above Examples is to re-send the one time value at a second time quantum later than the first time quantum to cause a credit transaction to occur to enable the user to receive a credit for the transaction, where the one time value is invalid for new transactions at the second time quantum.

In Example 10, the first logic of one or more of the above Examples is to re-generate the one time value at the second time quantum responsive to a request for the credit transaction.

In Example 11, the first logic is further to receive a second random number, generate a second pseudo random number seed based on the second random number, the second pseudo random number seed associated with the first account, and generate a sequence of second pseudo random number seeds based on the second pseudo random number seed, where each level of the sequence of second pseudo random number seeds is associated with a monetary range.

In Example 12, the communication logic is to send a selected second pseudo random number seed with the one time value, the selected second pseudo random number seed associated with the monetary range in which a cost of the transaction is included.

In Example 13, the processor of one or more of the above Examples is to enable the first logic to operate in a trusted execution environment.

Note that the above processor can be implemented using various means.

In an example, the processor comprises a system on a chip (SoC) incorporated in a user equipment touch-enabled device.

In another example, a system comprises a display and a memory, and includes the processor of one or more of the above examples.

In Example 14, a method comprises: receiving a one time value and a pre-authorization value from a merchant at a first server associated with a clearing house, the one time value associated with a customer and the pre-authorization value for a transaction to occur between the customer and the merchant; receiving a pseudo random number associated with the customer from an acquiring bank; calculating a computed one time value for a time quantum associated with the transaction using the pseudo random number; determining if the computed one time value matches the one time value; if the computed one time value matches the one time value, communicating the pre-authorization value to the acquiring bank to request a pre-authorization; and responsive to receipt of the pre-authorization from the acquiring bank, sending a pre-authorization approval to the merchant.

In Example 15, the method of Example 14 further comprises sending a pre-authorization denial if the computed one time value does not match the one time value.

In Example 16, the method of Example 14 further comprises receiving a credit score transaction code associated with the customer from the merchant.

In Example 17, the method of Example 16 further comprises receiving a denial for the pre-authorization, where the clearing house is to send credit event data associated with the transaction to a credit score provider that provided a second random number to the customer and the clearing house, and from which the credit score transaction code was generated.

In Example 18, the one time value is based on the time quantum and further based on an amount associated with the pre-authorization value.

In Example 19, the one time value comprises a first value and a second value to bound the transaction with regard to time and financial amount.

In another example, a computer readable medium including instructions is to perform the method of any of the above Examples.

In another example, a computer readable medium including data is to be used by at least one machine to fabricate at least one integrated circuit to perform the method of any one of the above Examples.

In another example, an apparatus comprises means for performing the method of any one of the above Examples.

In Example 21, a system comprises: a processor including a security logic to: receive, from a first service, a random number associated with a consumer and decode an encoding scheme associated with the random number; generate a seed tree based on the random number and the encoding scheme to provide a plurality of levels of pseudo random number seed values; and associate one of the plurality of levels of pseudo random number seed values with a credit score of the consumer; and at least one storage medium coupled to the processor to store the credit score in association with the random number.

In Example 22, the security logic of Example 21 is to receive a credit score transaction code and receive credit event data for a transaction associated with the consumer from an acquiring bank.

In Example 23, the processor is to update the credit score based on the credit event data and provide the updated credit score to the acquiring bank.

In Example 24, after the transaction is completed, the security logic is to receive a second credit score transaction code and second credit event data for the transaction, where the processor is to further update the credit score based on the second credit event data and store the further updated credit score in the at least one storage medium.

In Example 25, a system comprises: means for receiving a one time value and a pre-authorization value from a merchant at a first server means associated with a clearing house, the one time value associated with a customer and the pre-authorization value for a transaction to occur between the customer and the merchant; means for receiving a pseudo random number associated with the customer from an acquiring bank; means for calculating a computed one time value for a time quantum associated with the transaction using the pseudo random number; means for determining if the computed one time value matches the one time value; means for communicating the pre-authorization value to the acquiring bank to request a pre-authorization if the computed one time value matches the one time value; and means for sending a pre-authorization approval to the merchant responsive to receipt of the pre-authorization from the acquiring bank.

In Example 26, the system of Example 25 further comprises means for sending a pre-authorization denial if the computed one time value does not match the one time value.

In Example 27, the system of Example 25 further comprises means for receiving a credit score transaction code associated with the customer from the merchant.

Understand that various combinations of the above examples are possible.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A processor comprising:
a first logic to receive a random number associated with a user of a first computing system, generate a first pseudo random number seed based on the random number, the first pseudo random number seed associated with a first account of the user, and generate a sequence of pseudo random number seeds based on the first pseudo random number seed, wherein a first leaf of the sequence of pseudo random number seeds comprises a one time value associated with the first account; and
a communication logic to communicate the one time value to a second computing system associated with a merchant, wherein a credit entity is to authorize a transaction occurring at a first time quantum based at least in part on the one time value.

2. The processor of claim 1, wherein the communication logic is to communicate the one time value without user identifying information.

3. The processor of claim 1, wherein the random number is to be shared with the credit entity, and the credit entity is to generate a computed one time value based thereon and authorize the transaction if the computed one time value matches the one time value.

4. The processor of claim 1, wherein the one time value comprises a virtual credit card.

5. The processor of claim 1, wherein the first logic comprises an entropy multiplexer comprising one or more pseudo random number generators (PRNGs), each pseudo random number generator to generate a sequence of one or more pseudo random numbers based upon a pseudo random number seed.

6. The processor of claim 5, wherein the entropy multiplexer comprises a random number generator tree having a plurality of levels to generate one or more random numbers at each level of the plurality of levels, wherein a first random number generated by a first random number generator on a first level is to feed a second random number generator on a second level lower than the first level, the second random number generator to generate a random number sequence comprising two or more random numbers.

7. The processor of claim 6, wherein the first level includes a multiplicity of random number generators fed by a corresponding multiplicity of first random number seeds, the first random number seeds to be generated for a first time quantum, and the second level includes a multiplicity of random number generators fed by a corresponding multiplicity of second random number seeds, the second random number seeds to be generated for a second time quantum smaller than the first time quantum.

8. The processor of claim 6, wherein each of the plurality of levels is associated with a different time quantum, and the one time value is associated with the first time quantum of the transaction.

9. The processor of claim 1, wherein the communication logic is to re-send the one time value at a second time quantum later than the first time quantum to cause a credit transaction to occur to enable the user to receive a credit for the transaction, wherein the one time value is invalid for new transactions at the second time quantum.

10. The processor of claim 9, wherein the first logic is to re-generate the one time value at the second time quantum responsive to a request for the credit transaction.

11. The processor of claim 1, wherein the first logic is further to receive a second random number, generate a second pseudo random number seed based on the second random number, the second pseudo random number seed associated with the first account, and generate a sequence of second pseudo random number seeds based on the second pseudo random number seed, wherein each level of the sequence of second pseudo random number seeds is associated with a monetary range.

12. The processor of claim 11, wherein the communication logic is to send a selected second pseudo random number seed with the one time value, the selected second pseudo random number seed associated with the monetary range in which a cost of the transaction is included.

13. The processor of claim 1, wherein the processor is to enable the first logic to operate in a trusted execution environment.

14. At least one computer readable storage medium comprising instructions that when executed enable a system to:
receive a one time value and a pre-authorization value from a merchant at a first server associated with a clearing house, the one time value associated with a customer and the pre-authorization value for a transaction to occur between the customer and the merchant;
receive a pseudo random number associated with the customer from an acquiring bank;
calculate a computed one time value for a time quantum associated with the transaction using the pseudo random number;
determine if the computed one time value matches the one time value;
if the computed one time value matches the one time value, communicate the pre-authorization value to the acquiring bank to request a pre-authorization; and
responsive to receipt of the pre-authorization from the acquiring bank, send a pre-authorization approval to the merchant.

15. The at least one computer readable medium of claim 14, further comprising instructions that when executed enable the system to send a pre-authorization denial if the computed one time value does not match the one time value.

16. The at least one computer readable medium of claim 14, further comprising instructions that when executed enable the system to receive a credit score transaction code associated with the customer from the merchant.

17. The at least one computer readable medium of claim 16, further comprising instructions that when executed enable the system to receive a denial for the pre-authorization, wherein the clearing house is to send credit event data associated with the transaction to a credit score provider that provided a second random number to the customer and the clearing house, and from which the credit score transaction code was generated.

18. The at least one computer readable medium of claim 14, wherein the one time value is based on the time quantum and further based on an amount associated with the pre-authorization value.

19. The at least one computer readable medium of claim 18, wherein the one time value comprises a first value and a second value to bound the transaction with regard to time and financial amount.

20. A system comprising:
a processor including a security logic to:
receive, from a first service, a random number associated with a consumer and decode an encoding scheme associated with the random number;
generate a seed tree based on the random number and the encoding scheme to provide a plurality of levels of pseudo random number seed values; and
associate one of the plurality of levels of pseudo random number seed values with a credit score of the consumer; and
at least one storage medium coupled to the processor to store the credit score in association with the random number.

21. The system of claim 20, wherein the security logic is to receive a credit score transaction code and receive credit event data for a transaction associated with the consumer from an acquiring bank.

22. The system of claim 21, wherein the processor is to update the credit score based on the credit event data and provide the updated credit score to the acquiring bank.

23. The system of claim 22, wherein after the transaction is completed, the security logic is to receive a second credit score transaction code and second credit event data for the transaction, wherein the processor is to further update the credit score based on the second credit event data and store the further updated credit score in the at least one storage medium.

24. The system of claim 20, wherein the security logic is to code the transaction to occur with a first interest rate based on a characterization of the credit score associated with the transaction.
